(19) United States
(12) Patent Application Publication
(10) Pub. No.: US 2008/0004023 A1
(43) Pub. Date: Jan. 3, 2008

(54) Cell reselection method and system using an active measurement set in a mobile communication

(75) Inventors: Yih-Shen Chen, Hsinchu City (TW); Han-Chiang Liu, Dahu Shiang (TW)

Correspondence Address: BACON & THOMAS, PLLC, 625 SLATERS LANE, FOURTH FLOOR, ALEXANDRIA, VA, 22314, US

(73) Assignee: Sunplus Technology Co., Ltd., Hsinchu (TW)

(21) Appl. No.: 11/822,074

(22) Filed: Jul. 2, 2007

(30) Foreign Application Priority Data
Jul. 3, 2006 (TW) 095124163

(51) Int. Cl. H04Q 7/20

(52) U.S. Cl. 455/436; 455/434

(57) ABSTRACT

A cell reselection method and system using an active measurement set in a mobile communication, which determines whether the user equipment enters in a power-saving mode based on the signal strength and strength variability of a serving cell and the mobile feature of a user equipment. In the power-saving mode, in accordance with the signal strength of neighboring cells on the serving cell, an active measurement set is formed with cells that are selected from the neighboring cells broadcasted by a WCDMA system and have stronger signals. The user equipment only requires measuring the cells in the active measurement set. Thus, since the cell number of the active measurement set is smaller than that defined by the WCDMA system, the number of neighboring cells required to be measured is reduced, so as to reduce the power dissipation and increase the idle time on the user equipment.

### BACKGROUND OF THE INVENTION

1. Field of the Invention

The invention relates to the technical field of cell reselection in a mobile communication and, more particularly, to a cell reselection method and system using an active measurement set in a mobile communication.

2. Description of Related Art

In order to maintain steady communication quality in 3G mobile communication systems such as Wideband Code Division Multiple Access (WCDMA), a network-end typically selects a suitable base station (BTS) for serving connection of a cellphone, which is referred to as a handoff. When the cellphone is in idle, the network-end broadcasts the messages of the serving cell and neighboring cells, and the comparison conditions of cell reselection, but the actual right of cell reselection is given to the cellphone for determination.

The cell reselection can allow the cellphone in an idle mode to obtain a best serving cell. The cellphone in the idle mode continuously measures the signal strength of the serving cell and neighboring cells of the serving cell. When the signal strength of the serving cell is too low and the signal strength of a neighboring cell is significantly higher, the cell reselection is activated. In accordance with the determination equations defined by the 3G mobile communication systems, the cellphone can select a best and suitable cell.

In a cell reselection evaluation process, when the signal quality of the serving cell is lower than a value assigned by the network-end, the cellphone performs a signal quality measurement on the neighboring cells of the serving cell to accordingly find the best suitable cell. FIG. 1 is a schematic graph of an activation of a conventional cell reselection process. As shown in FIG. 1, when the signal quality Sx of the serving cell is greater than S_{intrasearch}, it indicates that the quality Sx is acceptable and the cell reselection is not activated. When the signal quality Sx of the serving cell is smaller than or equal to S_{intrasearch} and greater than S_{intersearch}, the cellphone performs an intrafrequency measurement. When the signal quality Sx of the serving cell is smaller than or equal to S_{intersearch} and greater than S_{searchRATm}, the cellphone performs an interfrequency measurement. When the signal quality Sx of the serving cell is smaller than or equal to S_{searchRATm}, the cellphone performs an inter-RAT measurement. The notations S_{intrasearch}, S_{intersearch} and S_{searchRATm} are the measurement-activated values of neighboring cells respectively with a same frequency, different frequency and different system (such as Global System for Mobile Communications, GSM) than the serving cell.

3G WCDMA system broadcasts the network information to a cellphone in order to thereby inform it of the information of the serving cell and neighboring cells. Thus, the cellphone can conveniently and periodically measure the signal strength of cells. However, when the conditions of activating a measurement are met, the cellphone has to measure all neighboring cells (at most, 32×3=96) broadcasted by the network-end, which wastes the time and also increases the power dissipation. In addition, the neighboring cells are not located all around the cellphone, and even the movement of the cellphone has a certain direction. Accordingly, measuring all neighboring cells is not efficient. When the cellphone is in the idle mode without connections, the continuous signal measurement may increase the power dissipation and significantly reduce the idle time on the cellphone. Therefore, an improvement to the typical cell reselection for 3G WCDMA systems is desired.

### SUMMARY OF THE INVENTION

An object of the invention is to provide a cell reselection method and system using an active measurement set in a mobile communication, which can reduce the number of neighboring cells required to be measured in the cell reselection method to thereby reduce the power dissipation and increase the idle time.

Another object of the invention is to provide a cell reselection method and system using an active measurement set in a mobile communication, which can dynamically change an active measurement set to more accurately determine the neighboring cells to be measured, thereby avoiding the power dissipation.

A further object of the invention is to provide a cell reselection method and system using an active measurement set in a mobile communication, which can prolong the measurement interval in the cell reselection method to thereby reduce the power dissipation and increase the idle time.

In accordance with one aspect of the present invention, there is provided a cell reselection method using an active measurement set in a mobile communication to thereby save power consumption of a user equipment. The method includes the steps of: (A) measuring a received signal code power sent by a serving cell; (B) subtracting a last received signal code power from the received signal code power to thereby obtain a received signal code power difference; (C) computing a mobility index based on a location information of the user equipment; (D) switching the user equipment to a power-saving mode when the received signal code power, the received signal code power difference and the mobility index meet with conditions that allow the user equipment to enter in the power-saving mode; (E) measuring all neighboring cells on the serving cell to thereby obtain signal qualities respectively; (F) selecting cells from the neighboring cells to form an active measurement set based on the signal qualities; (G) re-measuring the signal qualities respectively for the serving cell and the neighboring cells of the active measurement set every predetermined time; (H) executing step (E) when a signal quality measured in step (G) is lower than a signal quality threshold.

In accordance with another aspect of the present invention, there is provided a cell reselection system using an active measurement set in a mobile communication. The system includes a serving cell and a user equipment. The serving cell transmits and receives a wireless signal over a service region thereof. The user equipment receives the wireless signal transmitted by the serving cell and sends the wireless signal to the serving cell. The user equipment in a power-saving mode measures all neighboring cells on the serving cell to thereby obtain signal qualities respectively, and selects cells from the neighboring cells based on the signal qualities to thereby form an active measurement set. The user equipment re-measures the signal qualities respectively for the serving cell and the neighboring cells of the active measurement set every predetermined time. When a signal quality of a cell re-measured every predetermined time is lower than a signal quality threshold, the active measurement set is reconstructed by re-measuring all neighboring cells on the serving cell.

Other objects, advantages, and novel features of the invention will become more apparent from the following detailed description when taken in conjunction with the accompanying drawings.

### BRIEF DESCRIPTION OF THE DRAWINGS

FIG. 1 is a schematic graph of an activation of a typical cell reselection process;

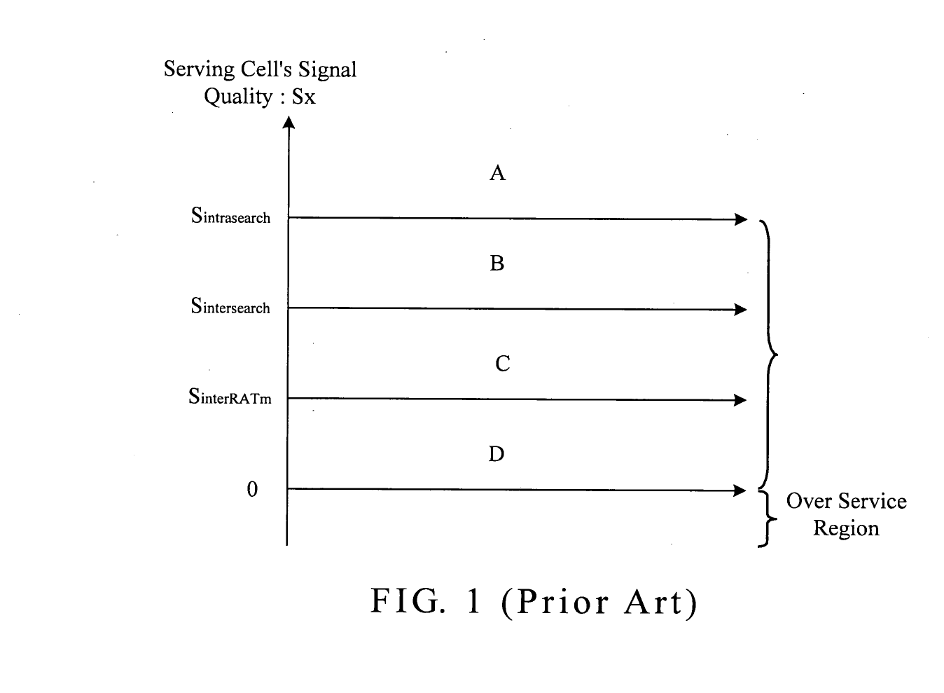

FIG. 2 is a schematic view of a cell reselection system using an active measurement set in a mobile communication in accordance with the invention;

FIG. 3 is a flowchart of a user equipment entering in a power-saving mode in accordance with the invention;

FIG. 4 is a schematic view of a location information computed by an observed time difference of arrival; and

FIG. 5 is a flowchart of a cell reselection method using an active measurement set in a mobile communication in accordance with the invention.

### DETAILED DESCRIPTION OF THE PREFERRED EMBODIMENT

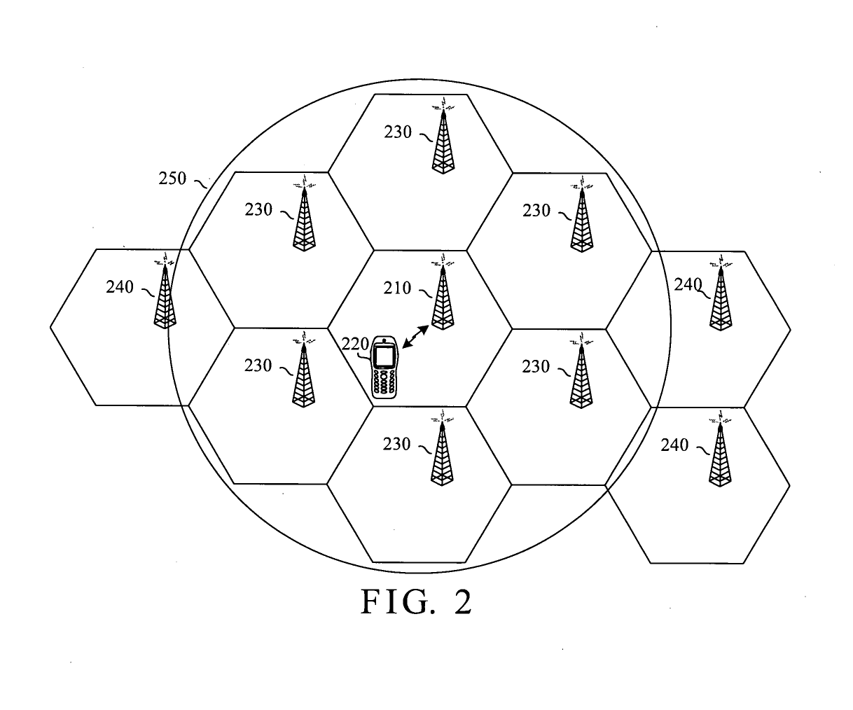

FIG. 2 is a schematic view of a cell reselection system using an active measurement set in a mobile communication in accordance with the invention. As shown in FIG. 2, the system includes a serving cell 210 and a user equipment 220.

The serving cell 210 transmits and receives a wireless signal over a service region. The user equipment 220 receives the wireless signal transmitted by the serving cell 210 and sends the wireless signal to the serving cell 210. The user equipment 220 in a power-saving mode measures all neighboring cells 230, 240 on the serving cell to thereby obtain a signal quality, and selects cells from the neighboring cells 230, 240 and form an active measurement set 250 based on the signal quality. The user equipment 220 measures signal qualities for the serving cell 210 and the neighboring cells 230 of the active measurement set 250 every predetermined time T. When a signal quality of a neighboring cell of the active measurement set is lower than a signal quality threshold, the active measurement set 250 is reconstructed by re-measuring all neighboring cells 230, 240 on the serving cell 210.

The cell number contained in the active measurement set 250 is smaller than the number of neighboring cells on the serving cell 210. The user equipment 220 measures the received signal code powers (RSCPs) of a common pilot channel (CPICH) respectively sent by the serving cell 210 and the neighboring cells of the active measurement set 250 as a reference of the signal qualities.

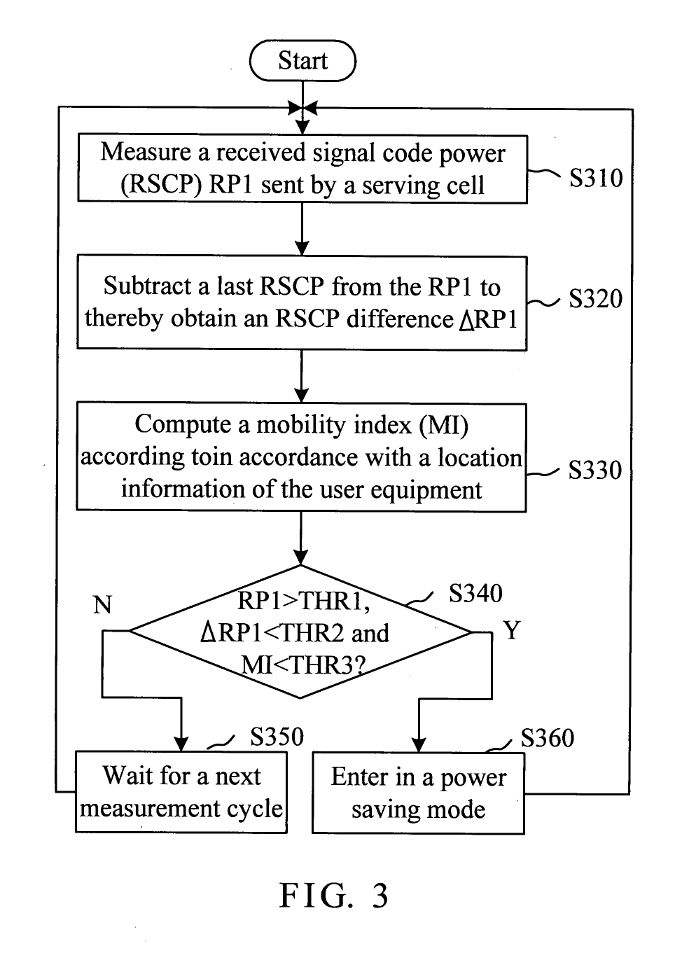

FIG. 3 is a flowchart of the user equipment 220 entering into the power-saving mode in accordance with the invention. As shown in FIG. 3, step S310 measures the received signal code power, denoted as RP1, of the CPICH sent by the serving cell 210. Step S320 subtracts a last received signal code power from RP1 to thereby obtain an RSCP difference, denoted as ΔRP1.

Step S330 computes and defines a mobility index (MI) in accordance with the location information (LI) of the user equipment 220. The user equipment 220 can obtain the LI of the user equipment 220 from a global positioning system (GPS). In addition, the user equipment 220 can obtain a cell reselection rate (CR) in practice. The MI of the user equipment 220 can be computed by the following equation (1):

MI=α(ΔRP1)+β(LI)+γ(CR), α+β+γ=1 (1)

where α, β and γ are each a weighting value.

In this embodiment, the LI is obtained from a GPS in the user equipment 220. However, in other embodiments, an observed time difference of arrival (OTDOA) method can be used to compute the LI of the user equipment 220. Namely, a computation unit in the user equipment 220 provided with the OTDOA method is employed as a location information extractor.

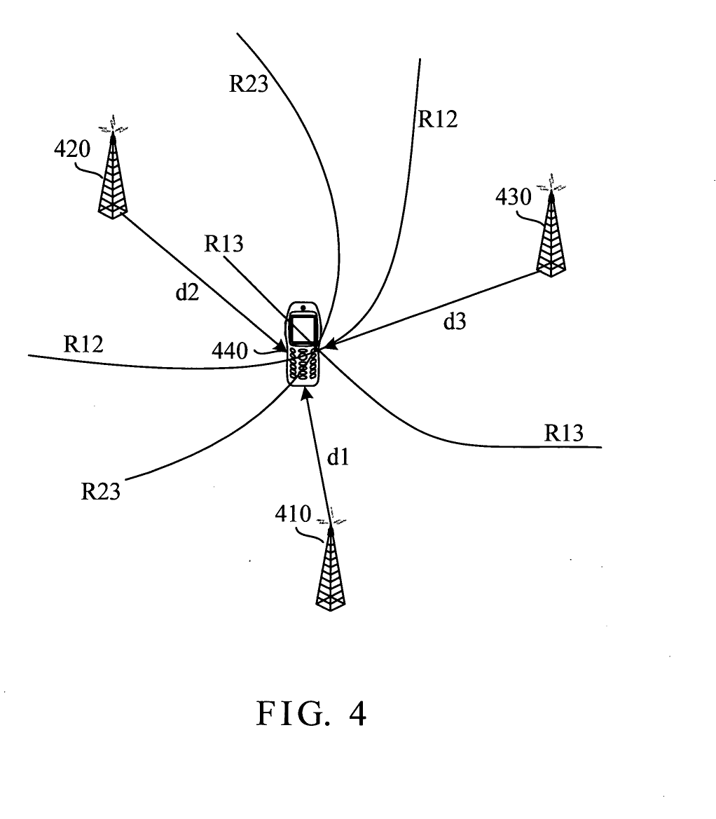

FIG. 4 is a schematic view of the location information (LI) computed by the observed time difference of arrival (OTDOA) method. The OTDOA method essentially uses a user equipment 440 to measure a pilot signal sent by the cells 410, 420, 430 respectively. The pilot signal is sent by the CPICH and has a primary scramble code. The user equipment 440 can use the primary scramble code to identify the cells to send the CPICH.

As shown in FIG. 4, the notations d1, d2 and d3 are pilot signal propagation delays respectively from the cells 410, 420, 430 to the user equipment 440. In addition, the OTDOA between the cells 410 and 420 is represented by R12=d2−d1, the OTDOA between the cells 420 and 430 is represented by R23=d3−d2, and the OTDOA between the cells 430 and 410 is represented by R13=d3−d1. The OTDOAs R12, R23 and R13 are each a hyperbola respectively. The user equipment 440 is located at the intersection of R12, R23, R13. Namely, the user equipment 440 measures the pilot signal propagation delays to compute the OTDOAs, and accordingly computes the LI of the user equipment 220.

The user equipment 220 can use a counter, a timer and a divider to compute a cell reselection rate (CR) thereof. For each cell reselection performed by the user equipment 220, the counter is increased by one, and the divider divides the content of the counter by the content of the timer to thereby obtain the CR of the user equipment 220.

In step S340, when the RSCP (RP1), the RSCP difference (ΔRP1), and the MI meet with the predetermined conditions, the user equipment 220 enters in the power saving mode (S360) defined in the invention, and conversely, step S350 is executed to wait for a next measurement cycle followed a return to step S310.

In this case, when the RSCP (RP1) is greater than a first threshold THR1, it indicates that the wireless signal quality sent by the serving cell 210 is good. When the RSCP difference (ΔRP1) is smaller than a second threshold THR2, it indicates that the RSCP is steady without a significant change. When the MI is smaller than a third threshold THR3, it indicates that the moving speed of the user equipment 220 is not very quick. When the conditions cited above are met, the user equipment 220 enters in the power saving mode (S360).

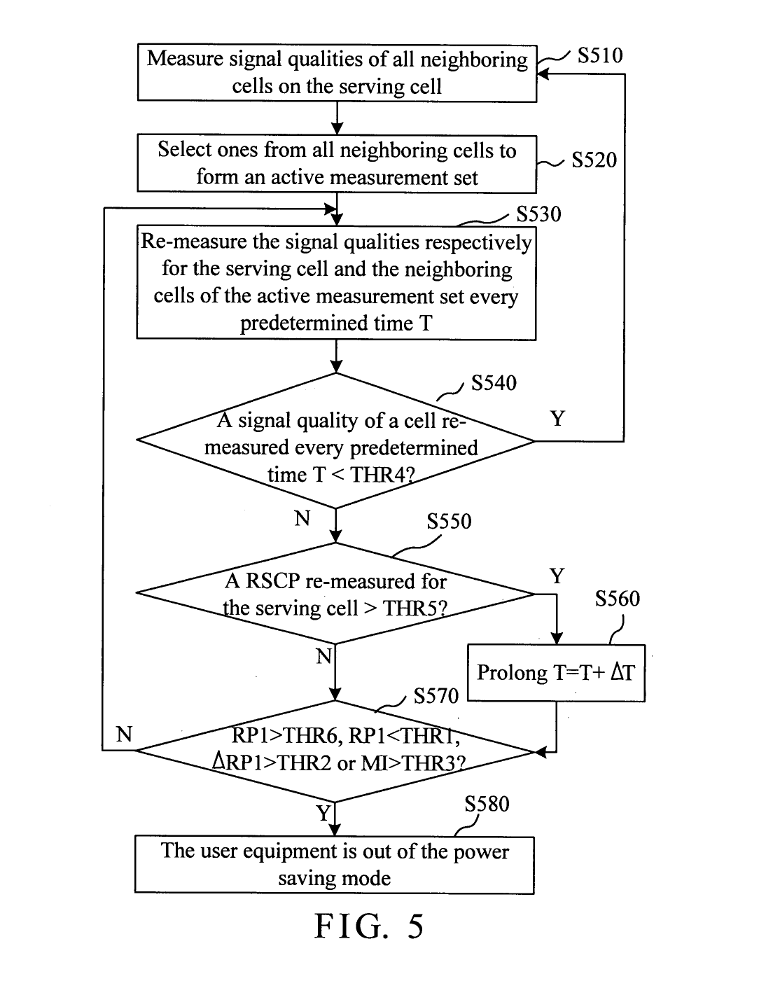

FIG. 5 is a flowchart of a cell reselection method using an active measurement set in a mobile communication in accordance with the invention, which is executed when the user equipment 220 enters in the power saving mode to thereby save the power consumption of the user equipment 220. As shown in FIG. 5, step S510 measures all neighboring cells on a serving cell to thereby obtain the signal qualities. The user equipment 220 measures the RSCPs of the CPICH sent by the serving cell and the neighboring cells that are regarded as a reference of signal quality. In general, according to the WCDMA system standard, the number of all neighboring cells is 96 (32×3).

Step S520 selects cells from the neighboring cells based on the signal qualities to thereby form an active measurement set. For example, the active measurement set is collected by selecting the first N neighboring cells in an RSCP order from high to low, where N is a positive integer. In general, certain neighboring cells possibly are not around the user equipment 220. In this case, it is not required to measure all neighboring cells, thereby achieving the purpose of saving the power.

In other embodiments, the active measurement set can be collected by selecting the neighboring cells with an RSCP greater than M dB.

Step S530 re-measures signal qualities respectively for the serving cell and the neighboring cells of the active measurement set every predetermined time T. In this case, the RSCPs of the serving cell and the neighboring cells of the active measurement set are measured as a reference of signal quality. The user equipment 220 obtains its mobility information from the serving cell 210.

Step S540 determines whether the RSCP of a cell measured in step S530 is lower than a signal quality threshold THR4. When step S540 decides that the RSCP of a cell measured in step S530 is lower than a signal quality threshold THR4, step S510 is re-executed. Namely, when the signal quality of the cell becomes poor and lower than the threshold THR4, the signal strengths of all neighboring cells of the serving cell are re-measured to thereby form a new active measurement set.

Step S550 is based on the RSCPs measured in step S530 to determine whether the RSCP of the serving cell is greater than a power threshold THR5; if yes, the predetermined time T is prolonged. Namely, when the RSCP of the serving cell is greater than the power threshold THR5, it indicates that the distance between the user equipment 220 and the base station of the serving cell is very short, and the probability of activating the cell reselection is very low. Thus, the period of measurement time is prolonged, i.e., T=T+ΔT.

When the RSCP of the serving cell is not greater than the power threshold THR5, step S570 is executed. Step S570 determines whether the user equipment 220 is out of the power saving mode based on the measurement in step S530 and the mobility information. When the measurement in step S530 and the mobility information do not meet with one of the conditions entering in the power saving mode, the user equipment 220 is out of the power saving mode (S580) and, otherwise, step S530 is re-executed. Namely, step S570 determines whether the conditions of the user equipment 220 entering in the power saving mode are still met. When one of the conditions RP1>THR1, ΔRP1<THR2 and MI<THR3 is not met, the user equipment 220 is out of the power saving mode and measures the signal strength (return to step S310 of FIG. 3). Alternatively, when the signal quality of the serving cell does not meet with a measurement threshold THR6 defined by the network-end, the user equipment 220 also stops the evaluation of entering the power saving mode in addition to exiting from the power saving mode, wherein THR6>THR1.

In view of the foregoing, it is known that the invention makes use of the signal strength of the serving cell, strength variability of the serving cell and the mobile feature of a user equipment to determine whether or not the user equipment enters in a power-saving mode. In the power-saving mode, according to the signal strength of neighboring cells of the serving cell, an active measurement set is formed with cells that are selected from the neighboring cells broadcasted by a WCDMA system and have stronger signals. The user equipment only requires measuring the cells in the active measurement set. Thus, since the cell number of the active measurement set is smaller than that defined by the WCDMA system, the number of neighboring cells required to be measured is reduced, as compared with the prior cell reselection, to thereby reduce the power dissipation and increase the idle time on the user equipment. In addition, the invention also provides a determinant for updating the active measurement set, thereby dynamically adjusting the active measurement set and more accurately deciding the cells to be measured. Thus, the power dissipation on the user equipment is avoided. Further, in the power saving mode, if the signal strength of the serving cell is stronger than a threshold, the period of measurement time of the neighboring cells is prolonged, which can further reduce the power consumption of the user equipment.

Although the present invention has been explained in relation to its preferred embodiment, it is to be understood that many other possible modifications and variations can be made without departing from the spirit and scope of the invention as hereinafter claimed.

What is claimed is:

1. A cell reselection method using an active measurement set in mobile communication, which saves power consumption of a user equipment, the method comprising the steps of:
(A) measuring a received signal code power (RSCP) sent by a serving cell;
(B) subtracting a last received signal code power from the received signal code power to thereby obtain a received signal code power difference;
(C) computing a mobility index based on a location information of the user equipment;
(D) switching the user equipment to a power-saving mode when the received signal code power, the received signal code power difference and the mobility index (MI) meet with conditions that allow the user equipment to enter in the power-saving mode;
(E) measuring all neighboring cells of the serving cell to thereby obtain signal qualities respectively;
(F) selecting cells from the neighboring cells to form the active measurement set based on the signal qualities;
(G) re-measuring the signal qualities respectively for the serving cell and the neighboring cells of the active measurement set every predetermined time; and
(H) executing step (E) when a signal quality measured in step (G) is lower than a signal quality threshold.

2. The method as claimed in claim 1, wherein step (G) measures the received signal code power of a common pilot channel respectively sent by the serving cell and the neighboring cells of the active measurement set to thereby obtain re-measured the received signal code power as a reference of the signal qualities.

3. The method as claimed in claim 2, further comprising the step of:
(I) prolonging the predetermined time when the re-measured the received signal code power of the serving cell is greater than a power threshold based on the re-measured the received signal code power in step (G).

4. The method as claimed in claim 1, wherein step (G) further obtains mobility information of the user equipment from the serving cell.

5. The method as claimed in claim 4, further comprising the step of:
(J) when the measurement in step (G) and the mobility information do not meet with the conditions that allow the user equipment to enter in the power-saving mode, the user equipment being out of the power saving mode.

6. The method as claimed in claim 2, wherein step (F) selects first N neighboring cells in an order of the received signal code power from high to low, where N is a positive integer.

7. The method as claimed in claim 2, wherein step (F) selects the neighboring cells, which have the received signal code power greater than M dB, to form the active measurement set, where M is a positive integer.

8. The method as claimed in claim 1, wherein step (C) computes the MI of the user equipment by a following equation:
MI=α(ΔRP1)+β(LI)+γ(CR), α+β+γ=1,
where MI indicates the mobility index, ΔRP1 indicates the received signal code power difference, LI indicates a location information of the user equipment, CR indicates a cell reselection rate, and α, β and γ are weighting values respectively.

9. The method as claimed in claim 8, wherein step (C) uses an observed time difference of arrival method to compute the location information of the user equipment.

10. The method as claimed in claim 8, wherein step (C) uses a global positioning system to provide the location information of the user equipment.

11. A cell reselection system using an active measurement set in mobile communication, comprising:
a serving cell, which transmits and receives a wireless signal over a service region thereof; and
a user equipment, which receives the wireless signal transmitted by the serving cell and sends the wireless signal to the serving cell;
wherein the user equipment in a power-saving mode first measures neighboring cells of the serving cell to thereby obtain signal qualities respectively, then selects cells from the neighboring cells according to the signal qualities to thereby form the active measurement set, and finally re-measures the signal qualities respectively for the serving cell and the neighboring cells of the active measurement set every predetermined time such that, when the signal quality of a cell re-measured every said predetermined time is lower than a signal quality threshold, the active measurement set is reconstructed by re-measuring neighboring cells of the serving cell.

12. The system as claimed in claim 11, wherein the number of the neighboring cells of the active measurement set is smaller than the number of all neighboring cells on the serving cell.

13. The system as claimed in claim 12, wherein the user equipment measures received signal code powers of a common pilot channel respectively sent by the serving cell and the neighboring cells as a reference of the signal qualities measured.

14. The system as claimed in claim 12, wherein the user equipment comprises a location information extractor to provide the location information of the user equipment, and the user equipment measures said received signal code power sent by the serving cell, subtracts a last received signal code power from the received signal code power to thereby obtain a received signal code power difference, computes a mobility index based on the location information, and enters in the power saving mode when the RSCP, the RSCP difference and the MI meet with conditions that allow the user equipment to enter in the power saving mode.

15. The system as claimed in claim 14, wherein the MI of the user equipment is computed by a following equation:
MI=α(ΔRP1)+β(LI)+γ(CR), α+β+γ=1,
where MI indicates the mobility index, ΔRP1 indicates the RSCP difference, LI indicates a location information of the user equipment, CR indicates a cell reselection rate, and α, β and γ are each weighting values respectively.

16. The system as claimed in claim 15, wherein the location information extractor is a global positioning system (GPS).

17. The system as claimed in claim 15, wherein the location information extractor is a computation unit provided with an observed time difference of arrival (OTDOA) process.
